(19) United States
(12) Patent Application Publication
(10) Pub. No.: US 2009/0201251 A1
(43) Pub. Date: Aug. 13, 2009

(54) Computer Mouse with Glide Pads for Reduced Friction and Noise

(76) Inventor: Jack Lo, Pacifica, CA (US)

Correspondence Address: JACK LO, 617 VIEWRIDGE DRIVE, PACIFICA, CA, 94044, US

(21) Appl. No.: 12/030,388

(22) Filed: Feb. 13, 2008

(51) Int. Cl. G06F 3/033; G06F 3/039

(52) U.S. Cl. 345/163; 248/346.01

(57) ABSTRACT

A computer mouse includes a bottom and glide pads attached to convex mounting surfaces on the bottom. The glide pads are flexible enough to conform to the convex mounting surfaces. A surrounding outer portion of each glide pad has a slightly angled surface relative to a mousing surface under the mouse to prevent the rims of the glide pads from scraping on the mousing surface. The mouse is thus moveable around on the mousing surface with reduced friction and noise.

### BACKGROUND OF THE INVENTION

1. Field of the Invention

The invention broadly relates to computer mouses.

2. Prior Art

A bottom view of a prior art computer mouse 10 is shown in FIG. 1. It includes a bottom 11 with a sensor 12 for tracking movement on a mousing surface such a desk or mouse pad. Glide pads 13 comprising a low friction material are attached to bottom 11 for reducing friction when mouse 10 is moved around on the mousing surface.

In the enlarged sectional view of mouse 10 in FIG. 2, each glide pad 13 projects slightly from bottom 11 to prevent bottom 11 from contacting mousing surface 17. Glide pad 13 is attached with adhesive 14 to a flat mounting surface 15 on bottom 11. Mounting surface 15 is recessed into bottom 11 in this example, but it may be coplanar with bottom 11 and surrounded with a downwardly projecting rim that keeps the glide pad in position. When mouse 10 is moved around on mousing surface 17, a rim 16 of glide pad 13 scrapes on surface imperfections or texture 18 (shown exaggerated) of mousing surface 17.

Another prior art computer mouse 20 shown in FIG. 3 includes glide pad 23 with a narrow beveled edge 26 formed when cut by a cutting die. Beveled edge 26 is still sharp enough to scrape on surface imperfections or texture 18 of mousing surface 17.

Other prior art mouses have glide pads in various shapes and patterns. In the example shown in FIGS. 5-6, a prior art mouse 30 has a bottom 31 with relatively large glide pads 33 attached with adhesive 34 to a flat mounting surface 35. Each glide pad 33 is large enough to be formed slightly convex from a flat sheet.

This inventor experimented extensively with prior art mouse with different glide pads, and discovered that flat glide pads such as shown in FIGS. 1-4 cause more friction and noise, whereas gently convex glide pads such as shown in FIGS. 5-6 cause less friction and less noise. However, when glide pads 33 are pressed by a finger, flat spots are created within the convex shape. In normal use, the pressure exerted on the glide pads by the weight of the hand on the mouse tends to flatten the glide pads, as shown in FIGS. 7-8. The flattened glide pads cause more friction and noise.

### BRIEF SUMMARY OF THE INVENTION

A computer mouse includes a bottom and glide pads attached to convex mounting surfaces on the bottom. The glide pads are flexible enough to conform to the convex mounting surfaces. A surrounding outer portion of each glide pad has a slightly angled surface relative to a mousing surface under the mouse to prevent the rims of the glide pads from scraping on the mousing surface. The mouse is thus moveable around on the mousing surface with reduced friction and noise.

### BRIEF DESCRIPTION OF THE SEVERAL VIEWS OF THE DRAWING

FIG. 1 is a bottom view of a prior art computer mouse with flat glide pads.

FIG. 2 is a sectional view of FIG. 1 taken along line 2-2.

FIG. 3 is a bottom view of a prior art computer mouse with flat glide pads with beveled edges.

FIG. 4 is a sectional view of FIG. 3 taken along line 4-4.

FIG. 5 is a bottom view of a prior art computer mouse with convex glide pads.

FIG. 6 is a sectional view of FIG. 5 taken along line 6-6.

FIG. 7 shows the prior art mouse of FIG. 5 when the glide pads are flattened.

FIG. 8 is a sectional view of FIG. 7 taken along line 8-8.

FIG. 9 is a bottom view of the present computer mouse with convex glide pads.

FIG. 10 is a sectional view of FIG. 9 taken along line 10-10.

FIG. 11 is another embodiment of the convex glide pads.

FIG. 12 is a bottom view of another embodiment of the present mouse.

FIG. 13 is a sectional view of FIG. 12 taken along line 13-13.

FIG. 14 is another embodiment of the convex glide pads.

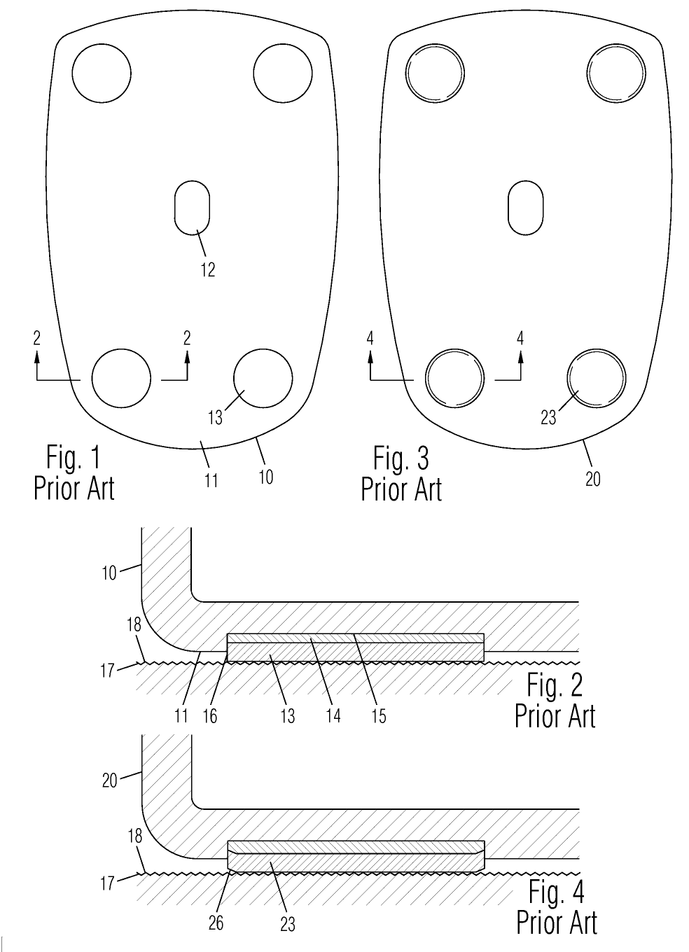

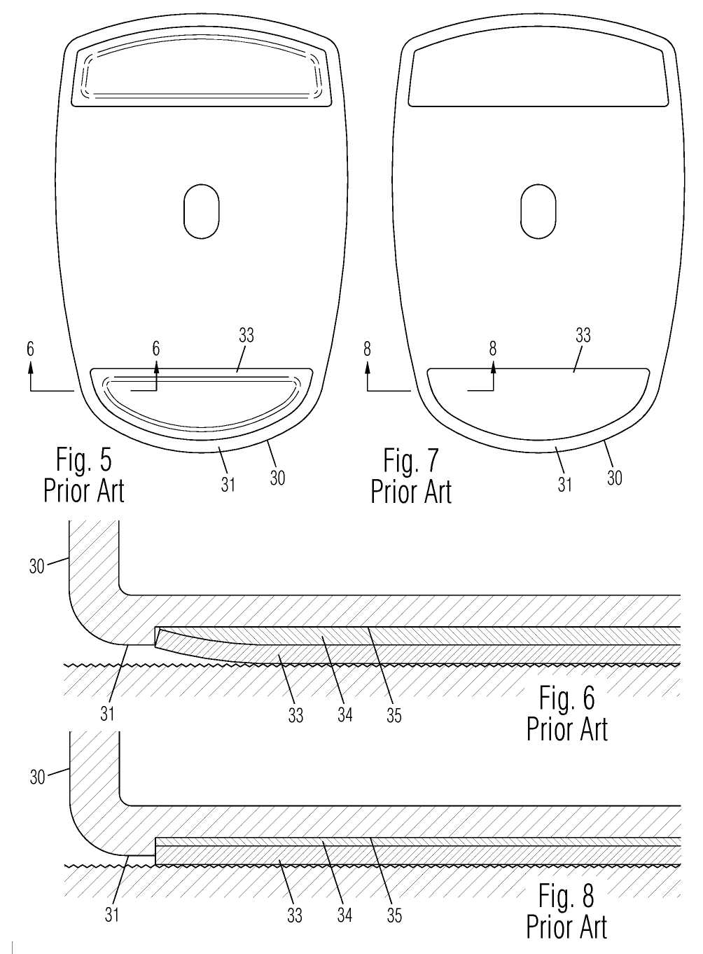

### DETAILED DESCRIPTION OF THE INVENTION

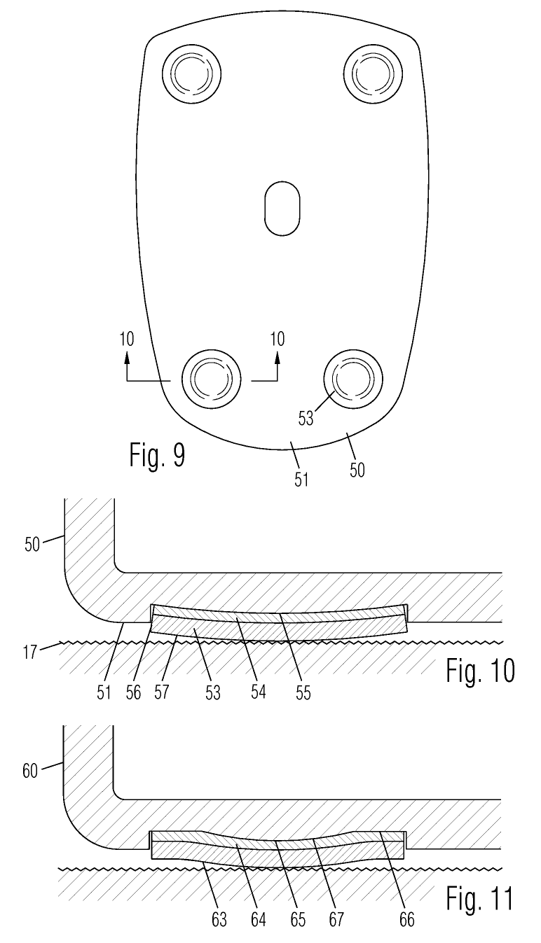

### FIGS. 9-11

In FIGS. 9 and 10, a computer mouse 50 includes a bottom 51, and glide pads 53 attached with adhesive 54 to convex mounting surfaces 55 on bottom 51. Glide pads 53 are comprised of a low friction material, such as the material made by DuPont under the trademark “TEFLON”, and are flexible enough to conform to convex mounting surfaces 55 when pressed on.

In this example, convex mounting surfaces 55 are recessed into bottom 51. Alternatively, the outer edges of convex mounting surfaces 55 may be coplanar with bottom 51, and the positions of glide pads 53 may be fixed by respective lips projecting downwardly from the perimeters of convex mounting surfaces 55.

When conformed to convex mounting surfaces 55, each glide pad 53 is provided with a slightly angled surface 57 in substantially all horizontal directions relative to a mousing surface 17 under mouse 50. Therefore a rim 56 of each glide pad 53 is prevented from contacting mousing surface 17, thus reducing friction and noise.

The convex mounting surfaces may have any suitable contour, such as smoothly curved, beveled, etc., as long as an inner portion projects downwardly more than a surrounding outer portion to lift the rims of the glide pads away from the mousing surface. In the example shown in FIG. 11, a mouse 60 has a glide pad 63 attached with adhesive 64 to a mounting surface 65 that includes a flat outer portion 66 surrounding a convex inner portion 67.

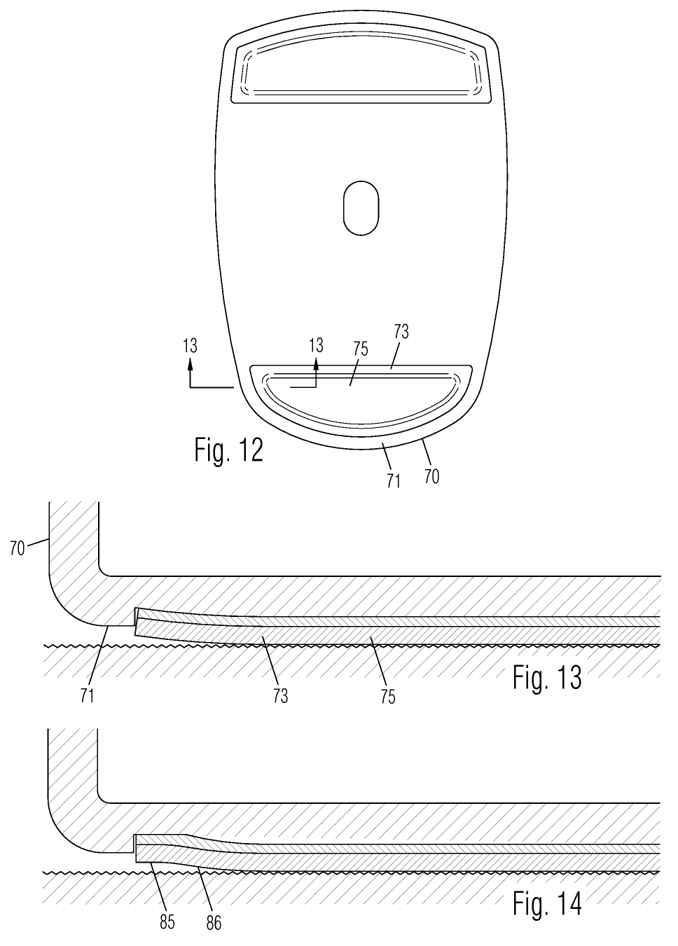

### FIGS. 12-14

The convex glide pads may be of any shape and size, and there may be a different number of glide pads than shown in these examples. In another example shown in FIGS. 12-13, a computer mouse 70 has a bottom 71 with fewer glide pads but each glide pad 73 is much larger than in FIG. 9. The sectional contour is similar to the contour in FIG. 10 but includes a wider inner portion 75. FIG. 14 shows a similar embodiment as FIGS. 12-13 but includes a flat outer portion 85 surrounding a convex inner portion 86.

Although the foregoing description is specific, it should not be considered as a limitation on the scope of the invention, but only as an example of the preferred embodiment. Many variations are possible within the teachings of the invention. For example, different attachment methods, fasteners, materials, dimensions, etc. can be used unless specifically indicated otherwise. The relative positions of the elements can vary, and the shapes of the elements can vary. Therefore, the scope of the invention should be determined by the appended claims and their legal equivalents, not by the examples given.

I claim:

1. A computer mouse for gliding on a mousing surface, comprising:
a bottom;
a convex mounting surface on the bottom; and
a glide pad conforming to the convex mounting surface, wherein the glide pad includes an angled surface relative to the mousing surface.

2. The computer mouse of claim 1, wherein the angled surface surrounds an inner portion of the glide pad projecting farthest from the bottom.

3. A computer mouse for gliding on a mousing surface, comprising:
a bottom;
a mounting surface on the bottom, wherein the mounting surface includes a flat outer portion surrounding a convex inner portion; and
a glide pad conforming to the mounting surface, wherein the glide pad includes an angled surface relative to the mousing surface.

4. The computer mouse of claim 3, wherein the angled surface surrounds an inner portion of the glide pad projecting farthest from the bottom.
